(19) United States
(12) Patent Application Publication
(10) Pub. No.: US 2007/0186645 A1
(43) Pub. Date: Aug. 16, 2007

(54) Arrangement for fill level measurement in a tank equipped with a sounding tube

(76) Inventors: Ingo Knudsen, Rieseby (DE); Matthias Boldt, Rummingen (DE)

Correspondence Address: BACON & THOMAS, PLLC, 625 SLATERS LANE, FOURTH FLOOR, ALEXANDRIA, VA, 22314, US

(21) Appl. No.: 10/572,800

(22) PCT Filed: Sep. 20, 2004
(86) PCT No.: PCT/EP04/10525

§ 371 Date: Jan. 3, 2007

(30) Foreign Application Priority Data
Sep. 23, 2003 (DE) 103 44 259.6

(51) Int. Cl. G01F 23/28; G08B 21/00

(52) U.S. Cl. 73/290 V; 340/612

(57) ABSTRACT

Fuel-, ballast-, utility- or freight-tanks of ships are frequently equipped with an open sounding tube, which serves for the mechanical sounding of the fill level of the medium in the tank. In the case of fill level measurements in the sounding tube with measuring devices, which work with microwave signals, it has been found that the wanted signals can be superimposed in a lower region of the sounding tube by strong disturbance signals, which come from the tank floor. In order to be able to determine reliably the fill level of the medium reliably in a tank equipped with such a sounding tube also by means of a microwave fill level measuring device, an arrangement is provided which includes a deflecting device for deflecting the microwave signals in an end region of the sounding tube. So that it will still be possible to perform sounding measurements in such tank using a mechanical sounding device, a microwave-transmissive support is provided for the plumb device in the region of the deflecting device.

The invention relates to an arrangement for measuring fill level of a medium in a tank equipped with a sounding tube.

Such arrangements are known, for example, from tank installations, where a sounding tube open to the medium is provided in the tank for mechanical sounding of the fill level of the medium in the tank. For such purpose, a plumb, or the like, on a line, or a dipstick, is lowered into the medium to a defined bearing point and thereafter the covering, or wetting, of the plumb device with medium determined. Knowing the geometry of the tank interior, one can than ascertain the sought fill level in units of volume, or as a percent value. The sounding tube reaches usually deep into the tank and into the medium, but ends still above the tank floor.

Such tanks with sounding tubes are also known from ships, where the fill level of medium in a fuel-, ballast-, utility-, or freight-tank, for example, is to be measured under the special conditions at sea. Fill level measurements in tanks of ships are already also performed with fill level measuring devices working with microwave signals. The advantage of such measurements is that they do not depend on the density or temperature of the medium, nor do they depend on the pressure present in the tank.

In such case, it has been found that, in the case of measurements with microwave signals in media with low dielectric constant (DC: r<4), wanted signals are superimposed in a lower region of the sounding tube end by strong disturbance signals, which originate from the tank floor.

An object of the invention is to provide an arrangement which permits, in the case of a tank equipped with a sounding tube and using a fill level measuring device working with microwave signals, reliable determination of fill level also in the lower region of a sounding tube, especially for the case of a medium of small DC-value.

This object is achieved by an arrangement for measuring a fill level of a medium in a tank equipped with a sounding tube by means of a fill level measuring device, which works with microwave signals, wherein the arrangement includes a deflecting device for deflecting the microwave signals in an end region of the sounding tube.

In a special form of embodiment of the arrangement of the invention, the deflecting device includes a deflecting plate.

Other forms of embodiment of the arrangement of the invention concern the securement of the deflecting device.

In the case of yet another form of embodiment of the arrangement of the invention, the deflecting device is arranged at a predetermined angle to a longitudinal axis of the sounding tube.

In a further form of embodiment of the arrangement of the invention, the deflecting device is an angular plate.

In the case of yet another form of embodiment of the arrangement of the invention, the fill level measuring device includes a horn antenna, which protrudes into the sounding tube.

Yet another form of embodiment of the arrangement of the invention provides a Y-adapter in the sounding tube for a plumb device, wherein, in the region of the deflecting device, a microwave-transmissive support is positioned for the plumb device.

A special advantage of the invention is to be seen in the fact that the deflecting device arranged in the lower region of the sounding tube and/or between the end of the sounding tube and the tank floor assures that fill level measurements with microwave signals deliver reliable results, even when the DC-value of the medium being measured in the tank is small.

A further advantage of the invention is the opportunity for combining the deflecting device with a support for mechanical sounding probes, or plumbs, wherein the support is transmissive for microwave signals. This is important in tank installations where, besides the fill level measuring with microwaves, it is also important to be able to conduct fill level measurement by mechanical means.

The invention is suited, therefore, especially for ships and particularly for tanks in such locations, which are frequently filed with different media.

Particularly ship tanks are currently frequently equipped with these sounding tubes. By means of a suitable adapter, microwave fill level measuring devices can, in simple manner, be secured on these sounding tubes. With a suitable Y-adapter, which is mounted beneath such a fill level measuring device, a lateral, sealable opening and an access into the sounding tube is enabled, so that also in the case of mounted microwave fill level measuring device, the opportunity for a mechanical sounding-tube plumbing still remains.

The invention will now be explained and described in greater detail on the basis of examples of embodiments presented in the appended drawing, the figures of which show as follows:

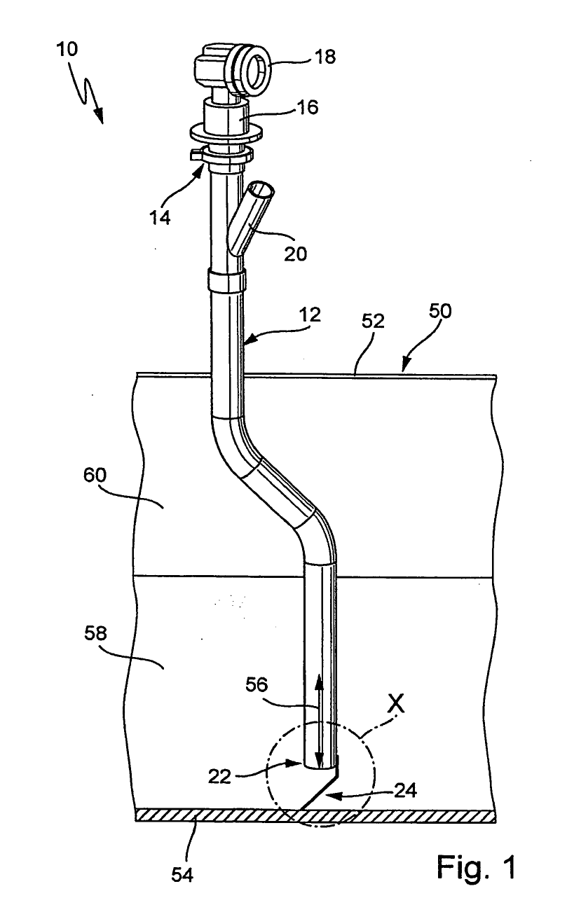

FIG. 1 a perspective drawing of an arrangement of the invention for measuring a fill level of a medium in a tank equipped with a sounding tube;

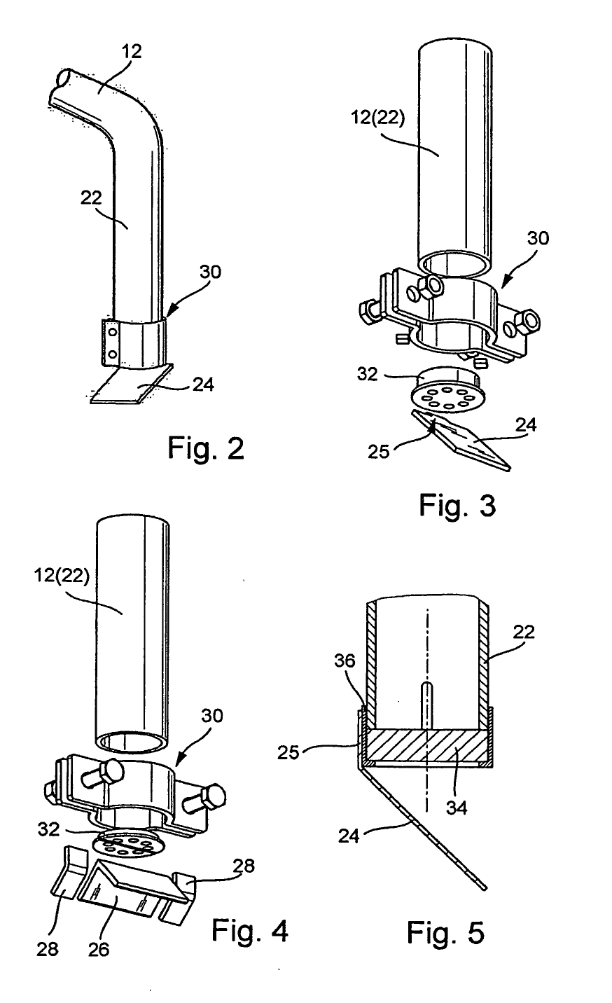

FIG. 2 a detail of the region “X” of the arrangement of FIG. 1;

FIG. 3 a perspective drawing, at enlarged scale, of a first example of an embodiment of a deflecting unit of the arrangement of the invention for measuring fill level;

FIG. 4 a perspective drawing, at enlarged scale, of a second example of an embodiment of a deflecting unit of the apparatus of the invention for measuring fill level; and

FIG. 5 a perspective drawing, at enlarged scale, of a third example of an embodiment of a deflecting unit of the arrangement of the invention for measuring fill level.

FIG. 1 shows an example of an embodiment of an arrangement 10 for measuring fill level according to the invention. Arrangement 10 includes a sounding tube 12, at the upper end 14 of which an adapter 16 has been placed, in order to facilitate securement of a fill level measuring device 18. As already described, the fill level measuring device in this case is one which works with microwave measuring signals. An antenna, preferably a horn antenna, as emitting and receiving mechanism of the fill level measuring device 18, protrudes into the sounding tube 12. The horn antenna does not appear in FIG. 1, since it is internal to the illustrated structure.

Sounding tube 12 extends into a tank 50, for example a tank on a ship. Visible are a tank roof 52 and a tank floor 54. Tank 50 is about half-filled in the drawing of FIG. 1 with a medium 58, for example a liquid medium having a low DC-value, such as e.g. gasoline, oil or liquefied petroleum gas. Above medium 58 is a gas phase 60.

Although not shown here, it will be evident to those skilled in the art that the sounding tube is secured to the tank roof 52. Equally evident to those skilled in the art are various ways in which such securement can be effected.

Provided beneath the adapter 16 for the fill level measuring device 18 is a Y-adapter 20, which enables a closable access to the interior of the sounding tube 12. This makes possible the introduction of a mechanical sounding device, for example a plumb or a probe, through the Y-adapter 20 into the sounding tube 12, for determining fill level of the medium 58, even in the presence of a mounted fill level measuring device 18.

On the lower end 22 of the sounding tube 12 is a deflecting device, preferably a deflecting plate 24. With this deflecting plate 24, undesired disturbance signals, which otherwise are superimposed on wanted signals picked-up by the fill level measuring device 18, are, according to the invention, blocked, or at least sufficiently weakened, such that the wanted signals for determining fill level can be unequivocally identified. The lower end 22 of the sounding tube 12 open for the medium 58 and the deflecting device are marked as detail X in FIG. 1 and illustrated more exactly in FIG. 1. The path of the microwave signals used for the fill level measurement is indicated in FIG. 1 by a double-arrow 56. Fill level measurement with microwaves is, per se, sufficiently known to those skilled in the art, so that such will not be gone into further here.

FIG. 2 shows the sounding tube 12, on whose lower end 22 the deflecting plate 24 is secured by means of a clamp 30 and a holding tab 25, which is hidden in this drawing but can be seen in FIG. 5, wherein the holding tab 25 can be mounted externally on the clamp 30, between sounding tube 12 and clamp 30, or in the interior of the sounding tube 12. Other securements of the deflecting plate 24 are, of course, not excluded. Deflecting plate 24 is inclined at a predetermined angle, for example 45°, with respect to the longitudinal axis of the sounding tube 12. Deflecting plate 24 is expediently so dimensioned that it extends across the cross section of the sounding tube 12.

FIG. 3 is a more exact drawing of the lower end 22 of sounding tube 12, deflecting plate 24 and a clamp 30 slightly modified compared with that shown in FIG. 2. A support 32, with holes distributed on it and made of a material which is transmissive for microwaves, preferably a suitable dielectric material, is inserted into the lower end 22 of sounding tube 12 and permits, on the one hand, the incursion of the medium 58 (see, in this connection, FIG. 1) into the sounding tube 12, and forms, on the other hand, a support, or barrier, for a mechanical sounding device inserted into the sounding tube 12 via the Y-adapter 20 (see, in this connection, FIG. 1).

Deflecting plate 24 is secured directly to the support 32 and is clamped together with such in the sounding tube 12 by the clamp 30. The holding tab 25 can, however, also be secured directly outside or inside on the clamp 30 and can, thus, be mounted together therewith on, or to, the sounding tube 12. Another opportunity for securement is to place the holding tab 25 between sounding tube 12 and clamp 30 as clamp 30 is being put in place, so that the deflecting plate 24 becomes fixed in position by the tightening of the clamp 30.

FIG. 4 shows another example of an embodiment of a deflecting device of the invention, wherein the deflecting plate 26 itself is angular. Also, in this case, the support 32 provided with holes and made of a material which is transmissive for microwaves is, as described above with respect to FIG. 3, inserted into the lower end 22 of the sounding tube 12. The angular deflecting plate 26 is, in this case, secured by means of two holders 28, one attached to each side, preferably in the form of slightly angled strips of plate material, as shown in FIG. 4, each being clamped in the clamp 30. The advantage of this angular deflecting plate 26 compared with the deflecting plate 24 of FIGS. 2 and 3 is that the angular deflecting plate 26 takes up less space beneath the lower end 22, while still given equal spanning of the cross section of the lower end 22 of the sounding tube 12.

Yet another example of an embodiment of the deflecting device of the invention and the support for the mechanical sounding probe is shown in FIG. 5. In this case, a window 34 transmissive for microwaves is provided in a rim 36. The deflecting plate 24 of FIGS. 2 and 3 is secured to rim 36 via the holding tab 25 and is, together with the rim 36 and the window 34, placed onto the sounding tube 12 and secured there. Window 34 is preferably made of a suitable dielectric material and likewise provided with holes, to permit incursion of the medium 58 (see, in this respect, FIG. 1) into the sounding tube 12, where its fill level can be measured.

1-9. (canceled)

10. An arrangement for measuring a fill level of a medium in a tank, including:
a sounding tube;
a fill level measuring device, which works with microwave signals; and
a deflecting device for deflecting microwave signals in an end region of said sounding tube.

11. The arrangement as claimed in claim 10, wherein:
said deflecting device includes a deflecting plate.

12. The arrangement as claimed in claim 10, wherein:
said deflecting device is secured within said sounding tube.

13. The arrangement as claimed in claim 10, wherein:
said deflecting device is secured externally on said sounding tube.

14. The arrangement as claimed in claim 10, wherein:
said deflecting device is arranged at a predetermined angle to a longitudinal axis of a sounding tube.

15. The arrangement as claimed in claim 10, wherein:
said deflecting device is an angular plate.

16. The arrangement as claimed in claim 10, wherein:
said fill level measuring device includes a horn antenna, which protrudes into said sounding tube.

17. The arrangement as claimed in claim 10, wherein:
in said sounding tube, a Y-adapter is provided for a plumb device; and
in the region of said deflecting device, a microwave-transmissive support is provided for said plumb device.

18. The use of the arrangement as claimed in claim 10 in a tank of a ship.
